(19) United States
(12) Patent Application Publication
(10) Pub. No.: US 2009/0063645 A1
(43) Pub. Date: Mar. 5, 2009

(54) SYSTEM AND METHOD FOR SUPPORTING MESSAGING USING A SET TOP BOX

(75) Inventors: Steven M. Casey, Littleton, CO (US); Gnanasegeran Selvadurai, Lafayette, CO (US); Angela Mitchell, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Qwest Communications Internatinal Inc., Denver, CO (US)

(21) Appl. No.: 12/147,665

(22) Filed: Jun. 27, 2008

Related U.S. Application Data
(63) Continuation-in-part of application No. 11/291,325, filed on Nov. 30, 2005.

(51) Int. Cl. G06F 15/16

(52) U.S. Cl. 709/206

(57) ABSTRACT

Tools are provided for supporting messaging about a video program using a set top box. Video information related to the video program is received and converted at the set top box and a display device is caused to display the video program. A message to be sent from a first user to a second user is created in accordance with input from the first user. The message is related to the video program. A set of at least one Internet Protocol (“IP”) packets comprising the message is generated. The set of at least one IP packets is transmitted from the set top box through an IP network to be received by an external device that is separate from the set top box.

### CROSS-REFERENCE TO RELATED APPLICATIONS

The present disclosure may be related to the following commonly assigned applications/patents, of which the entire disclosure of each is incorporated herein by reference: U.S. patent application Ser. No. ______, filed on a date even herewith by Casey et al. and entitled “CONTENT SYNDICATION TO SET TOP BOX THROUGH IP NETWORK” (attorney docket no. 020366-100100US); U.S. patent application Ser. No. 12/061,046, filed on Apr. 2, 2008 by Casey et al. and entitled “IPTV FOLLOW ME CONTENT SYSTEM AND METHOD” (attorney docket no. 020366-100300US); and U.S. patent application Ser. No. ______, filed on a date even herewith by Casey et al. and entitled “DYNAMIC INTERACTIVE ADVERTISEMENT INSERTION INTO CONTENT STREAM DELIVERED THROUGH IP NETWORK” (attorney docket no. 020366-100400US).

This application is a continuation-in-part of co-pending U.S. patent application Ser. No. 11/291,325 filed Nov. 30, 2005 entitled “PERSONAL BROADCAST CHANNELS,” which is hereby incorporated by reference, as if set forth in full in this document, for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to messaging, and more particularly, to messaging using a set top box.

### BACKGROUND

In recent years, personal text messaging has become very popular. This type of messaging can take any of several forms, including without limitation short message service (“SMS”) messages on wireless phones, online chat messages on computer systems, and the like. Meanwhile, television watching remains popular. It would be highly desirable if a television viewer is allowed to interact with other viewers and/or participants in the video program by messaging them.

Existing television systems, however, do not allow a first user to message a second user about a video program being viewed by the first user. For example, in a cable TV system, a first user is not able to use a set top box to send a second user a message about a TV program being delivered through the set top box. Needing to switch to a different system to accomplish this task is highly inconvenient. For example, the first user might need to first switch to a computer with an Internet connection, start up a messaging application, manually look up information about the TV program, and manually enter the information about the TV program before finally being able to send a message to the second user.

Additionally, the first user would need to work with two sets of input and display devices, one set for the TV and one set for the computer. Needing to follow what is being shown on a TV screen while typing and reading what is being typed on a separate computer screen can be both inefficient and awkward. Moreover, the redundancy in equipment takes up limited space and raises costs because there are two sets of equipment to buy and maintain.

Hence, there is a need for more robust tools to allow for interaction between television viewers.

### BRIEF SUMMARY

Embodiments of the invention provide novel tools for allowing interaction between television viewers and/or participants in a video program. In one set of embodiments, a set top box can be used to provide a messaging interface that allows a first user to communicate with a second user at a different location. In an aspect of some embodiments, the first user is able to send, to the second user, a message about a video program being viewed by the first user.

Merely by way of example, in accordance with some embodiments, the set top box causes the display device to display a menu of messaging functions. In one embodiment, a messaging function allows the first user to send a message by using a message template. The message template might include information, for example a program name, without requiring entry by the first user. In another embodiment, the message template and the video program appear simultaneously on the display device, and the message template includes an input field to allow the first user to enter additional message information. Hence, in a beneficial aspect of some embodiments, the set top box, television, and/or an associated input device can provide all necessary input and display devices for inter-user messaging, so that the first user does not need to purchase or use any other equipment, such as a PC, etc.

In yet another embodiment, a message received by the second user might cause the video program being viewed by the first user to be recorded at a device associated with the second user. In some embodiments, a messaging function allows the first user to initiate a voice call session between the first user and at least one participant in the video program. Additionally, in one embodiment, messaging functions allow the first user to either host or join a group chat session. In another embodiment, a messaging function allows the second user to share an instant messaging session with the first user.

Accordingly, in some embodiments, while the video program is being displayed, the set top box might also generate a message relating to the video program in accordance with input from the first user. In some aspects, the set top box might cause the video program to be displayed on a display device, for example, after the set top box receives and/or converts video information relating to the video program. In other aspects, the set top box might send the message from the first user to the second user by generating and transmitting a set of at least one Internet (“IP”) packets that include the message.

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods provided by various embodiments. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

In one set of embodiments, a method of supporting messaging about a video program using a set top box might include receiving, at the set top box, video information related to the video program. The method might also include converting, at the set top box, the video information to allow for display of the video program on a display device and displaying the video program on the display device. Additionally, the method might include receiving a request to display a menu of messaging functions, the request being entered by the first user. Moreover, the method might include subsequently displaying the menu of messaging functions; the menu of messaging functions might include: a first messaging function to send program information of the video program to another user, a second messaging function to join a group chat session, a third messaging function to host a group chat session, a fourth messaging function to initiate an instant messaging session, and a fifth messaging function to call in to the video program.

The method might further include receiving a selection from the menu of messaging functions, the selection being entered by the first user by pressing a portion of a remote control, and the selection is the third messaging function to host a group chat session. The method might then include receiving, at a group chat server and from the set top box, an initiating request to initiate the group chat session. The method might also include publishing, at the group chat server, a list of group chat sessions for each video program; the list of group chat sessions includes the group chat session.

The method might further include displaying a first version of a group chat interface, and the first version of the group chat interface includes other than an input field for allowing the first user to enter message information. Moreover, the method might include resizing a size of the video program such that both the video program and a second version of the group chat interface appear simultaneously on the display device; the second version of the group chat interface includes the input field to allow the first user to enter message information.

Additionally, the method might include creating, at the set top box and in accordance with input from a first user, a message to be sent from the first user to a second user, wherein the message is related to the video program. The method might then include generating, at the set top box, a set of at least one Internet Protocol (“IP”) packets that includes the message. The method might further include transmitting the set of at least one IP packets from the set top box through an IP network to be received by an external device, the external device being separate from the set top box.

In another set of embodiments, a method of supporting messaging about a video program using a set top box might include receiving, at the set top box, video information related to the video program. The method might also include converting, at the set top box, the video information to allow for display of the video program on a display device and causing the display device to display the video program. Additionally, the method might include creating, at the set top box and in accordance with input from a first user, a message to be sent from the first user to a second user, wherein the message is related to the video program. Moreover, the method might include generating, at the set top box, a set of at least one Internet Protocol (“IP”) packets comprising the message. Furthermore, the method might include transmitting the set of at least one IP packets from the set top box through an IP network to be received by an external device, the external device being separate from the set top box.

In yet another set of embodiments, a device for supporting messaging about a video program might comprise a processor and a computer readable medium in communication with the processor. In an aspect, the computer readable medium might have encoded thereon a set of instructions executable by the device to perform one or more operations. Merely by way of example, in some embodiments, the set of instructions might include instructions for receiving video information related to the video program; instructions for converting the video information to allow for display of the video program on a display device; instructions for causing the display device to display the video program; instructions for creating, in accordance with input from a first user, a message to be sent from the first user to a second user, wherein the message is related to the video program; instructions for generating a set of at least one Internet Protocol (“IP”) packets comprising the message; and/or instructions for transmitting the set of at least one IP packets from the set top box through an IP network to be received by an external device, the external device being separate from the set top box. In some embodiments, such a device might be incorporated within a larger distribution system, which might further include the display device and/or a storage device.

### BRIEF DESCRIPTION OF THE DRAWINGS

A further understanding of the nature and advantages of particular embodiments may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a block diagram illustrating a system for supporting messaging about a video program using a set top box, in accordance with various embodiments of the invention.

FIGS. 2a-2b are process flow diagrams illustrating a method for supporting messaging about a video program using a set top box, in accordance with various embodiments of the invention.

FIGS. 3a-3h illustrate exemplary screen displays in accordance with various embodiments of the invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent, however, to one skilled in the art that other embodiments of the present invention may be practiced without some of these specific details. In other instances, well-known structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In an aspect, certain embodiments of the invention include tools for supporting messaging using a set top box. As used herein, the term “messaging” is intended to be construed broadly as encompassing any type of electronic communication between two users, including in particular, text-based communication. For example, in one embodiment, a message might comprise an e-mail message, information about a video program, an instruction to record a video program, a request to initiate a voice call session, a chat message of a group chat session, and/or an instant message (e.g., a person-to-person text message that is sent and received generally instantaneously or in real-time) of an instant messaging session. It is noted that in order to fully support various messaging functions, the set top box might also support receiving a message. For example, in another embodiment, the set top box might notify a user that a new message has been received and/or allow the user to read an e-mail and view a video program on a same screen display.

Merely by way of example, in one embodiment, a set top box is configured to receive and/or convert video information and to cause a video program to be displayed on a television, perhaps in conventional fashion. The set top box might also be configured to support messaging functions, e.g., by displaying a menu of messaging functions (perhaps in response to a request from a user of the set top box), and then receive a menu selection from the first user. The menu selection might instruct the set-top box to send program information to another user. Accordingly, the set top box might display a message template for the first user. The message template might comprise program information pertaining to the video program and might allow the first user to enter an e-mail address (or some other identifier) of a recipient and/or any desired additional message information. Additionally, the message template and the video program might be resized such that they both appear simultaneously on the television. After the first user indicates the message is ready to be sent, the set top box might generate a set of at least one IP packets comprising the message and/or transmit the set of packets through an IP network to be received by an external device.

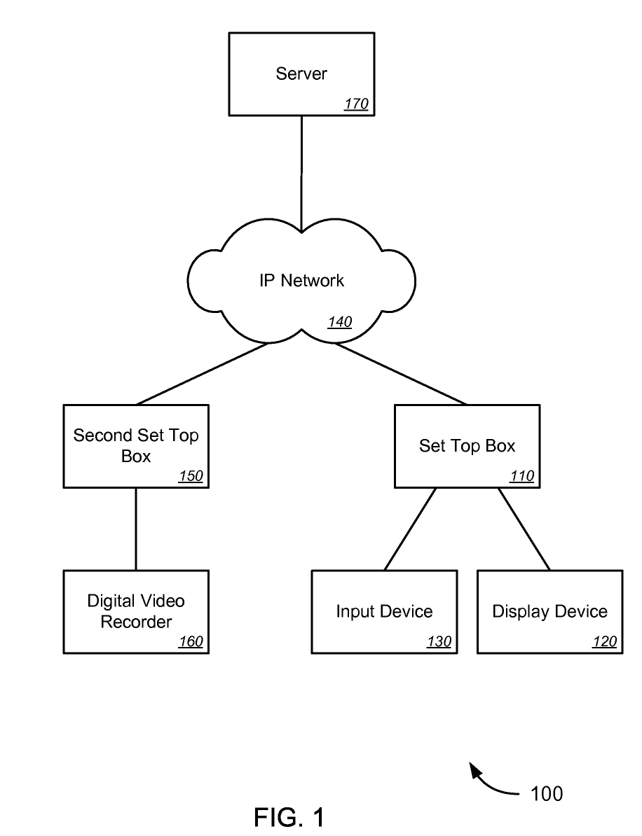

FIG. 1 illustrates an exemplary system 100 for supporting messaging about a video program using a set top box. It should be noted that, for descriptive purposes, the illustrated system 100 includes various elements that may not be included in certain embodiments of the invention. In accordance with the system 100, a set top box 110 is connected to a display device 120 and an input device 130. The set top box 110 is also connected to an IP network 140. Through the IP network 140, the set top box 110 might be connected to a server 170 and a second set top box 150. The second set top box 150 might be connected to a digital video recorder 160.

The set top box 110 might comprise various components for supporting messaging about a video program. Some of the components are directed to support a user interface that receives input from a user and causes images to be displayed for the user. Input from the user might be received through the input device 130. Examples of the input device 130 might include a remote control, a remote keyboard, and/or a remote pointing device including a mouse, a trackball, or a touchpad. To cause images to be displayed for the user, the set top box 110 might covert video information in order to generate and send a video signal to the display device 120. The display device 120 might be a television, a monitor, and/or the like.

Some of the components of the set top box 110 are directed to support communications through the IP network 140. The IP network 140 might be based on, without limitation, Internet Protocol versions 4 (“IPv4”) and/or 6 (“IPv6”). The set top box might connect to the IP network 140 through a wireless connection (e.g., Wi-Fi), Ethernet, or a modem, etc. In some embodiments, the set top box might additionally or alternatively communicate directly with the server 170 and/or the second set top box 150, bypassing the IP network 140. For example, in some aspects, the set top box might be more directly connected to the server 170 through a local loop including a fiber optic link, an xDSL connection, or a WiMAX link. In other aspects, the set top box might be more directly connected to the second set top box 150 including through a Wi-Fi or Ethernet connection. Additionally, it will be understood by those skilled in the art that a particular message might be sent or received through any combination of the above mentioned connections. For example, in one embodiment, a particular type of message might be sent through the IP network 140 but received through a direction connection to the server 170, while another particular type of message might be sent or received through a direct connection to the second set top box 150.

The server 170 might be a head-end server or a master controller that provides video programs to the set top box 110. The server 170 might also be a mail server capable of supporting protocols including Simple Mail Transfer Protocol (“SMTP”), Inter Message Access Protocol (“IMAP”), Post Office Protocol (“POP”), and/or other protocols. The server 170 might additionally be a telephony server capable of supporting voice call sessions and protocols including Session Initiation Protocol (“SIP”). Moreover, the server 170 might be a messaging server capable of supporting group chat sessions and/or instant messaging sessions. It will be understood by those skilled in the art that a single physical machine might be able to support all of the above features, and multiple physical machines, and/or multiple virtual machines might also be used in place of the server 170.

The second set top box 150 might be associated with a second user. The second set top box 150 might support features that are similar to those supported by the set top box 110 in order to support messaging between the first user and the second user. Accordingly, the second set top box might support its own user interface and connect to its own input device and/or display device. Additionally, the second set top box 150 might comprise or connect to a digital video recorder 160, so that a video program received by the second set top box 150 can be recorded at the digital video recorder 160. It is noted that the set top box 110 might also connect to its own digital video recorder so that a video program received by the set top box 110 can likewise be recorded at its own digital video recorder.

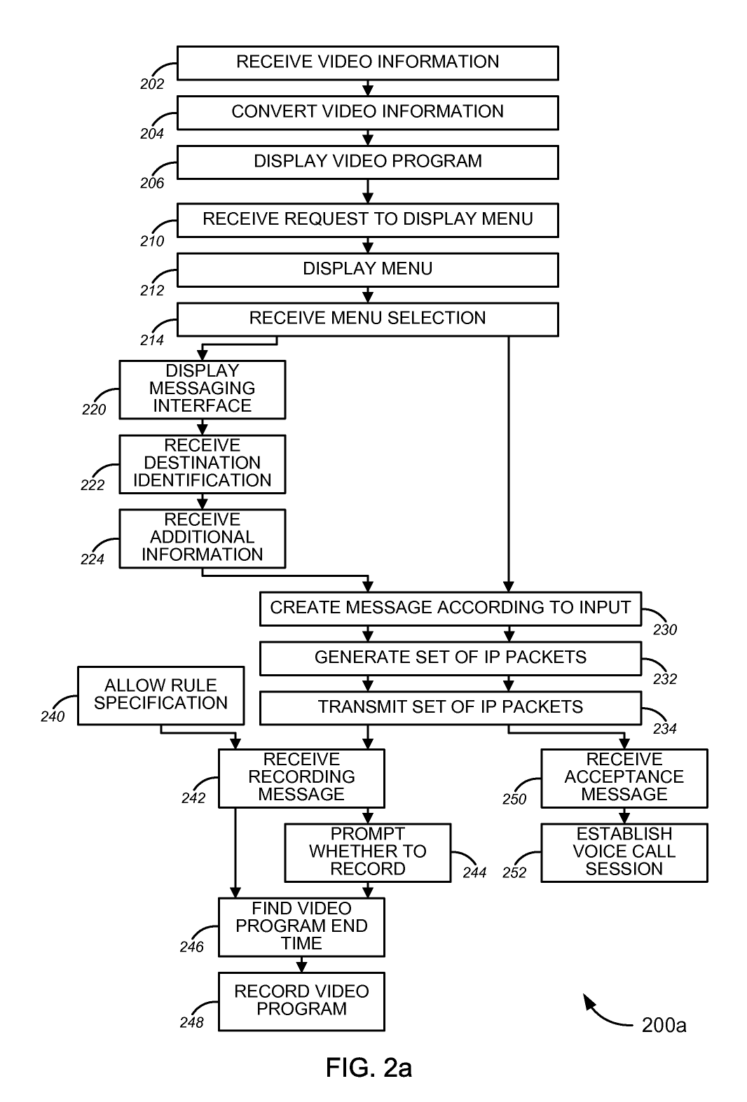

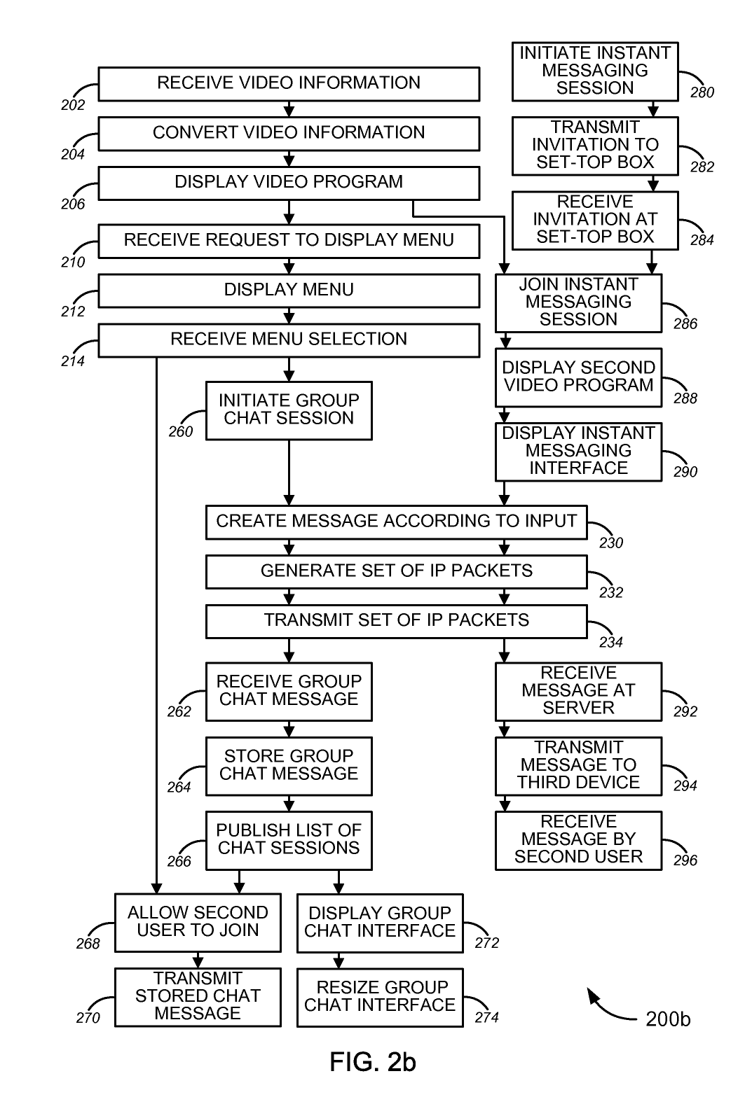

FIGS. 2a and 2b illustrate a method 200 for supporting messaging about a video program using a set top box, in accordance with certain embodiments of the invention. In some cases, the method 200 can be implemented by a system, for example the system 100 described above. It should be appreciated, however, that the system 100 of FIG. 1 may operate in a manner different than the method 200 of FIGS. 2a and 2b; likewise, it should be understood that the method 200 of FIGS. 2a and 2b may be implemented using any type of system and therefore is not limited to implementation in the system 100 of FIG. 1 (or any particular structural arrangement, for that matter).

In the method 200a of FIG. 2a, video information related to a video program is received at the set top box at block 202. For example, in an IP Television (“IPTV”) environment, the video information might be received in IP packets. At block 204, the video information is converted to allow the video program to be displayed on a display device. In some embodiments, the conversion might involve decrypting and decompressing Moving Picture Experts Group (“MPEG”) formatted video information into a video signal. At block 206, the video program is displayed on the display device. For example, in some embodiments, the set top box might send the video signal to a television, which causes the video program to be displayed on the display device.

At block 210, a first user might enter a request for a menu of messaging functions to be displayed. In one embodiment, this request might be entered by pressing a button or a portion of a remote control. In another embodiment, this request might be entered by pressing a key or a button of a remote keyboard. After receiving the request, the set top box might cause the display device to display the menu of messaging functions at block 212. For example, in some embodiments, the set top box might send a video signal that includes the menu of messaging functions to a television. The first user might then enter a selection from the menu of messaging functions, which is received by the set top box at block 214. For example, in one embodiment, the selection might be entered by first pressing a button on a remote control to scroll through the menu, and then pressing another button to enter the selection. In another embodiment, the up and down arrow keys and the enter key of a remote keyboard might be used. In other embodiments, the selection might be made directly by pressing a key of a remote keyboard or a portion of a remote control that corresponds to a particular messaging function. In these other embodiments, implementation of the menu of messaging functions might be optional.

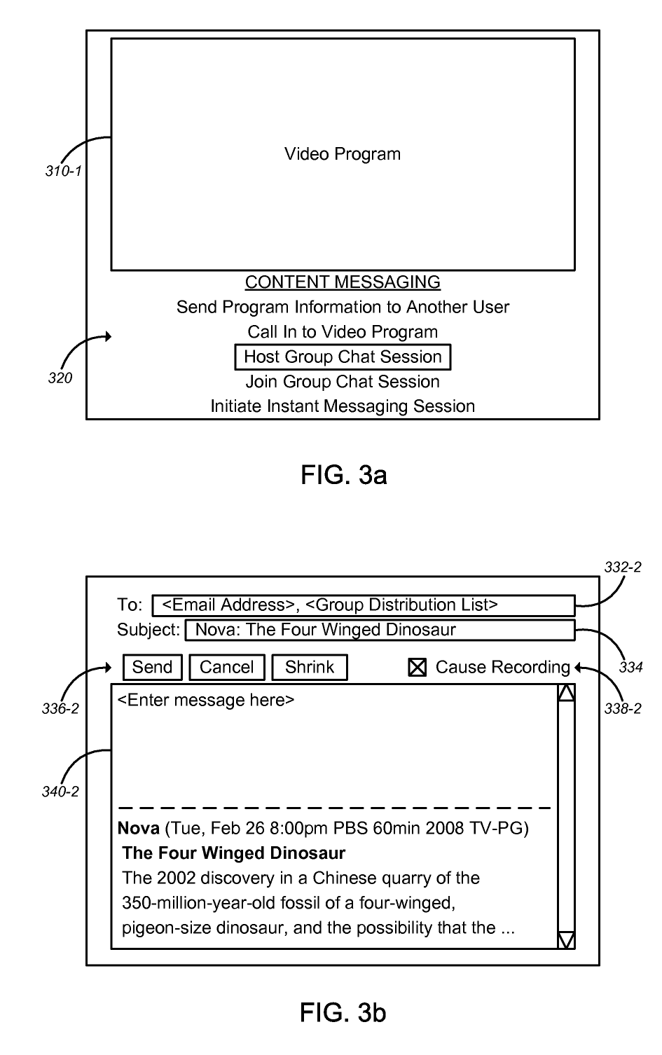

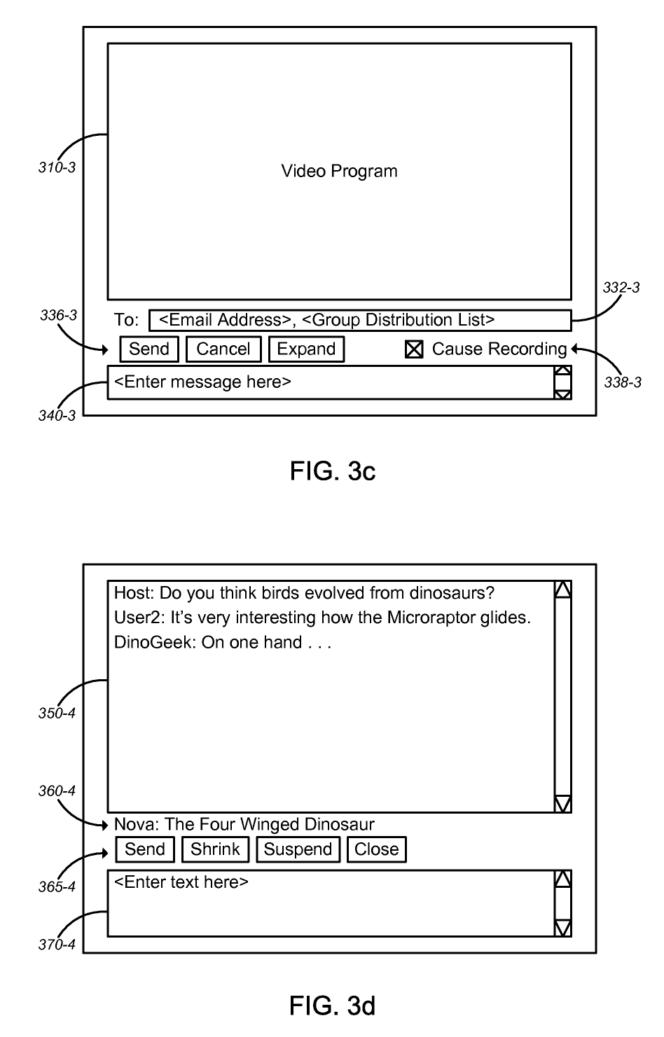

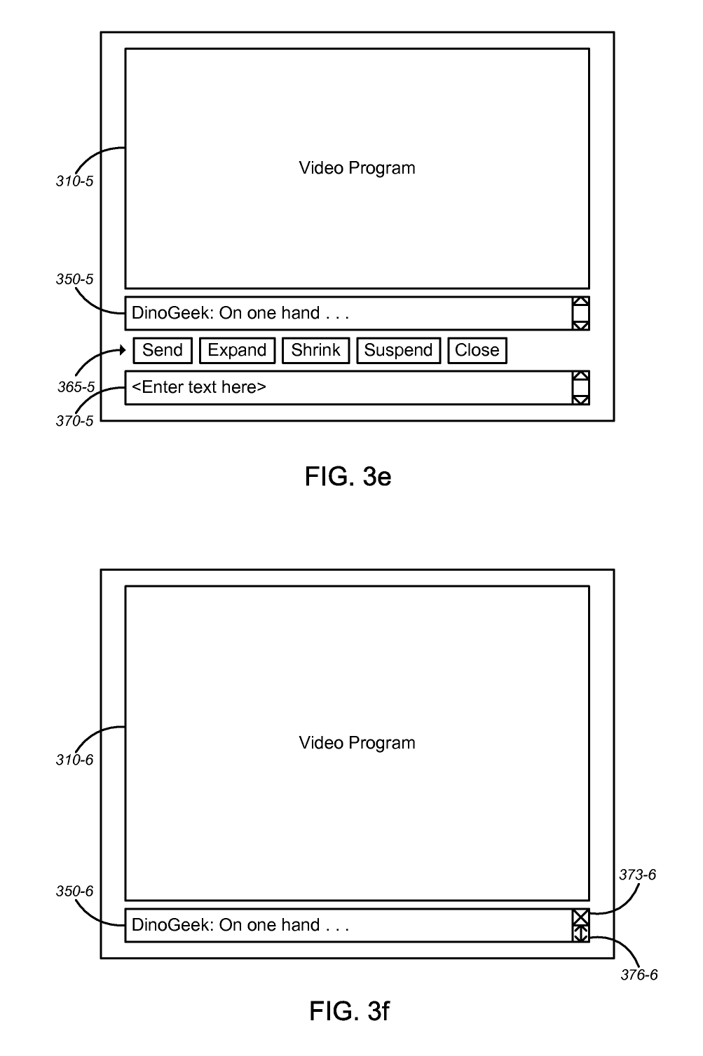

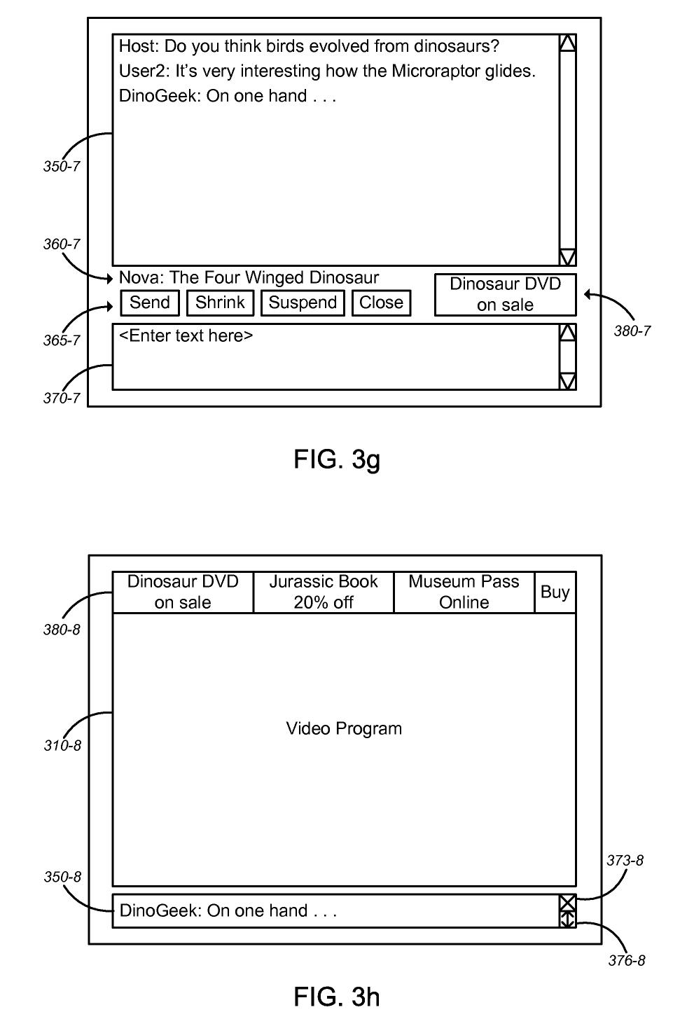

In FIG. 3a, an exemplary screen display (which might be displayed on a television screen, for example) in accordance with an embodiment of the invention is shown. A video window 310-1 for displaying a video program is shown as having been resized from its normal full-screen size. Below the video window 310-1, a menu 320 of messaging functions is shown. The menu 320 of messaging functions includes messaging functions to send program information to another user, call in to video program, host group chat session, join group chat session, and initiate instant messaging session. One of the messaging functions is highlighted so that if a button on the remote control is pressed, the set top box might consider that the highlighted messaging function has been selected by the first user. It is noted that in another embodiment, the menu 320 of messaging functions might appear above the video window 310-1 or might be overlaid on top of the video window 310-1. It should be appreciated that the screen display of FIG. 3a is merely exemplary in nature and is provided for purposes of illustration; in other embodiments, other techniques might be used to display information other than video (such as, for example, by overlaying the video window 310-1 with the menu 320, or by providing a box—similar to that used in a picture in picture technique—for the menu 320 within the video window 310-1, etc.).

Returning to FIG. 2a, if the messaging function selection entered by the first user is to send program information to another user, a messaging interface might be displayed on the display device at block 220, in accordance with some embodiments. For example, the messaging interface might include a message template that is presented to the first user. The message template might already include program information pertaining to the video program being viewed by the first user without requiring entry by the first user. The program information might be generated by the set top box to include a program name, a program date, and a program time. The first user might then be able to enter additional input via the messaging interface. For example, at block 222, the first user might enter an identification of a destination for the message via the messaging interface. This identification of the destination for the message can then be used when IP packets comprising the message is to be transmitted to the destination. At block 224, the first user might enter message information in addition to the program information in an input filed of the messaging interface. Accordingly, the additional message information might also be included in the set of IP packets comprising a content of the message template to be transmitted to the destination. Moreover, the first user might be able to indicate whether the video program should be recorded at a device at the destination as explained in greater detail below. In an embodiment, the first user might be able to navigate through the messaging interface (e.g., with up and down arrow keys on a remote control, and/or with various keys of a remote keyboard, and/or with a remote pointing device including a touchpad).

To illustrated these concepts, another exemplary screen display in accordance with an embodiment of the invention is shown in FIG. 3b. (As noted above, it should be appreciated that the display of FIG. 3b is merely exemplary in nature, and that other techniques could be used to display similar information.) A messaging interface is shown as including a destination input field 332-2, a subject input field 334, several action buttons 336-2, a checkbox 338-2 for indicating whether to cause recording at the destination, and an input field 340-2. The first user might be able to enter one or more destinations including one or more e-mail addresses and/or one or more group distribution list addresses in the destination input field 332-2. The subject input field 334 is shown as already including a program name without requiring entry by the first user. The text in the subject input field 334 may be modifiable by the first user. In one embodiment, the action buttons 336-2 include a button for sending the message, a button for canceling the message, and a button for resizing (e.g., shrinking) the messaging interface. The first user is able to indicate that the video program should be recorded at a device at the destination by checking the checkbox 338-2. The input field 340-2 is shown as already including a program name, a program date, a program time, and additional descriptions of the program. Space is also provided in the input field 340-2 for the first user to enter additional message information. In another embodiment, the action buttons 336-2 might be implemented as icons or other user interface elements.

If the button for resizing (e.g., shrinking) the messaging interface among the action buttons 336-2 is pressed by the first user, yet another screen display, as shown in FIG. 3c for example, may be displayed. (As noted above, the screen displays illustrated in the figures are exemplary in nature, and screen arrangements and techniques other than those illustrated in the figures could be used in accordance with various embodiments of the invention.) A size of the video window 310-3 is shown as being resized from its normal full-screen size. Below the video window 310-3, a messaging interface is shown as including a destination input field 332-3, several action buttons 336-3, a checkbox 338-3 for indicating whether to cause recording at the destination, and an input field 340-3. It is noted that, in some cases, a subject input field may be omitted from the display, in order to conserve screen space; in such cases, the subject input field might include default information generated by the set top box without requiring entry by the first user. Instead of the button for shrinking the messaging interface, the action buttons 336-3 include a button for expanding the messaging interface. If the button for expanding the messaging interface is pressed, a display like the exemplary screen display as shown in FIG. 3b, discussed above, might be displayed. The input field 340-3 might still include information, for example a program name, a program date, a program time, and additional descriptions of the program. However, because the input field 340-3 takes up less space in order to accommodate the video window 310-3, the user might need to scroll down the input field 340-3 in order to see the information. Space is still provided in the input field 340-3 for the first user to enter additional message information. It is noted that in another embodiment, the messaging interface might appear above the video window 310-3. In yet another embodiment, the action buttons 336-3 might be implemented as icons or other user interface elements.

Returning to FIG. 2a, if the button for sending the message among the action buttons is pressed by the first user, a message to be sent from the first user to a second user is created at block 230. The message is related to the video program, for example, because a subject of the message might include a program name of the video program by default. In another messaging function, the relationship between the message and the video program might be presented in a portion of the message other than the subject of the message. Subsequently, a set of at least one IP packets is generated comprising the message at block 232. For example, in an instance, the message might be encapsulated within one IP packet, while in another instance the message might be encapsulated into multiple IP packets, and the IP packets might be further fragmented. At block 234, the message (e.g., the set of at least one IP packets) is then transmitted from the set top box through the IP network to be received by an external device that is separate from the set top box.

As noted above, the first user might also be able to indicate (e.g., by checking a checkbox) whether the video program should be recorded at a device at the destination. The indication might be converted to a recording instruction that is included in the message when the message is created. In an embodiment, the device at the destination might be configured to record, based on the recording instruction, the video program at a digital video recorder. In this embodiment, the device might be a second set top box that is in communication with the digital video recorder. In some embodiments, prior to receiving the message, at block 240, the second set top box might allow the second user to specify a set of rules governing whether the second set top box will record the video program. In such embodiments, the external device might be further configured to record a video program based on the set of rules. For example, the second set top box might cause an interface to be displayed for the second user to enter a wild card string such that any program containing a particular string (e.g., “dinosaur”) will be recorded automatically. Another rule might match other portions of the message. For example, a rule might specify that a program is to be recorded automatically if the message is sent by a particular user. Yet another rule might specify that a program is not to be recorded if the message contains a particular word and was sent to a particular e-mail address (e.g., the e-mail address of a group distribution list that the second user subscribes to).

At block 242, the message indicating that the video program is to be recorded might be received at the second set top box. If no rule has been found that matches the message, the second set top box might prompt the second user to specify whether to record the video program at block 244 in some embodiments. The second user might be prompted by a pop up window that is displayed on the display device, or the second user might be prompted by an indication (e.g., an audible tone and/or visual indicator, including an LED that is lit) on a remote device, for example a remote control. Accordingly, the user is able to specify whether or not to record the video program. If an indication to record the video program is received from the second user in some embodiments, or if a rule that matches the message indicates that the video program is to be recorded automatically in other embodiments, the second set top box might next find an end time of the video program at block 246. For example, the second set top box might search a programming guide to find the end time in order to send a recording request to a digital video recorder that is in communication with the second set top box. Accordingly, at block 248, the video program is recorded at the digital video recorder based at least in part on the recording instruction in the message. Typically, the video program to be recorded at or near the second set top box is received from a source other than the set top box.

If the messaging function selection entered by the first user is to call in to the video program, the message that is created at block 230 might comprise a request to initiate a voice call session between the first user and at least one participant in the video program. At block 234, the set of at least one IP packets that is transmitted from the set top box through the IP network might be received by a server that is associated with a provider of the video program. The server might then accept the request to initiate the voice call session; the acceptance by the server is received at the set top box at block 250. Accordingly, the voice call session is established between the set top box and the server at block 252. In some embodiments, the voice call session might support at least a voice over IP communication, i.e., the voice call in addition to the initiating request are both carried via IP packets, between the first user and the at least one participant in the video program. In one embodiment, a telephone handset might be connected to the set top box to support this feature. In another embodiment, a microphone might be connected to the set top box to support audio input by the first user, and audio output might be directed to a television or set of speakers that normally plays audio from the video program. In other embodiments, audio input and output might be mixed and/or echo canceled with audio from the video program.

Attention is directed to the method 200b of FIG. 2b. If the messaging function selection entered by the first user is to host a group chat session, an initiating request to initiate the group chat session might be sent from the set top box to be received by a group chat server at block 260. In some embodiments, the set top box might first query the group chat server for a list of published group chat sessions to determine whether there already is an existing group chat session for the video program. If so, the set top box might prompt the first user whether the first user wishes to join one of the existing group chat sessions. If the first user is willing to join an existing group chat session, the effect of selecting the messaging function to host a group chat session might then be similar to selecting a messaging function to join a group chat session, to be described below.

In response to the user/set-top box initiating request to initiate the group chat session, the group chat server might establish the group chat session. It is noted that typically, the initiating request might include a program name to indicate that the group chat session is related to the video program being viewed by the first user. In some embodiments, the initiating request might include additional information or special note that is entered by the first user. The additional information or special note might be stored at the group chat server. After the group chat session has been established, the message that is created at block 230 might comprise a chat message of the group chat session. The chat message might be received at the group chat server at block 262. In some embodiments, the chat message might also be stored at the group chat server at block 264. At block 266, the group chat server might publish a list of group chat sessions, including the group chat session that was just initiated, for each program. In some embodiments, the group chat server might publish the list of group chat sessions as including the just initiated group chat session before receiving any chat message.

The set top box might then cause a group chat interface to be displayed on the display device for the first user, at block 272. In FIG. 3d, an exemplary screen display in accordance with an embodiment of the invention is shown. (As noted above, the screen displays illustrated in the figures are exemplary in nature, and screen arrangements and techniques other than those illustrated in the figures could be used in accordance with various embodiments of the invention.) The group chat interface is shown as including a chat messages field 350-4, a chat session name 360-4, several chat action buttons 365-4, and a chat input field 370-4. The chat messages field 350-4 includes chat messages that have been entered by each participant in the group chat session. The chat session name 360-4 might simply be the program name of the video program being viewed by the first user. In some embodiments, if the first user has added additional information to the initiating request, the additional information might also be displayed as part of the chat session name 360-4. For example, when the first user initiated the group chat session, “Springfield viewers” might have been added. Accordingly, “Springfield viewers” might be part of the chat session name 360-4.

The several chat action buttons 365-4 might include a send button for sending a message that has been entered in the chat input field 370-4, a shrink button for resizing the group chat interface, a suspend button for suspending the group chat session, and a close button for closing the group chat session. If the group chat session is suspended, the group chat interface might not be displayed and the video program might be displayed at its normal full-screen size. Later, the user might wish to resume the group chat session, and the exemplary screen display as shown in FIG. 3d might be displayed following an indication by the first user. For example, the first user might press a button on a remote control to resume a suspended session. Suspending a group chat session is different from closing a group chat session because, in an aspect, a group chat session cannot be resumed once closed. It is noted that the group chat session might still be carried on by the group chat server even if the first user, who initiated the group chat session, has closed the group chat session. The first user might still be able to join the group chat session again.

If the shrink button is pressed, an exemplary screen display in accordance with an embodiment of the invention as shown in FIG. 3e might be displayed. (As noted above, the screen displays illustrated in the figures are exemplary in nature, and screen arrangements and techniques other than those illustrated in the figures could be used in accordance with various embodiments of the invention.) In FIG. 3e, a size of the video window 310-5 for the video program is shown as being resized from its normal full-screen size. Below the video window 310-5, a group chat interface is shown as including a chat messages field 350-5, several chat action buttons 365-5, and a chat input field 370-5. It is noted that, in an embodiment, the several chat action buttons 365-5 might be replaced with icons or other user interface elements. In some embodiments, the group chat interface might appear above the video window 310-5. No chat session name is shown to conserve screen space. Additionally, a size of the chat messages field 350-5 is shown as being smaller than that of the corresponding field in FIG. 3d. In some embodiments, the last line or the last few lines of the chat messages might be displayed in the chat messages field 350-5. The several chat action buttons 365-5 might include a send button for sending a message that has been entered in the chat input field 370-5, an expand button for expanding the group chat interface, a shrink button for further shrinking the group chat interface, a suspend button for suspending the group chat session, and a close button for closing the group chat session.

If the expand button is pressed, the exemplary screen display as shown in FIG. 3d, discussed above, might be displayed instead of the exemplary screen display as shown in FIG. 3e. If the shrink button is pressed, an exemplary screen display in accordance with an embodiment of the invention as shown in FIG. 3f might be displayed. (As noted above, the screen displays illustrated in the figures are exemplary in nature, and screen arrangements and techniques other than those illustrated in the figures could be used in accordance with various embodiments of the invention.) In FIG. 3f, a size of the video window 310-6 is shown as having been resized from its normal full-screen size. Below the video window 310-6, a group chat interface is shown as including a chat messages field 350-6, a close icon 373-6 for closing the group chat session, and an expand icon 376-6 for expanding the group chat interface. In some embodiments, the group chat interface might appear above the video window 310-6. In other embodiments, the size of the video window 310-6 might still be displayed at its normal full-screen size, and the group chat interface might be overlaid on top of the video window 310-6. If the expand icon 376-6 is pressed, the exemplary screen display as shown in FIG. 3e, discussed above, might be displayed instead of the exemplary screen display as shown in FIG. 3f. No chat input field is shown to conserve screen space. Accordingly, this group chat interface might be used if the first user just wishes to follow discussions of a group chat session. If the first user wishes to provide input, the first user might expand the group chat interface to access the chat input field 370-5 as shown in FIG. 3e, and then shrink the group chat interface again.

Accordingly, a size of the group chat interface might be resized (to be either larger or smaller, as appropriate) at block 274. For example, the group chat interface as shown in FIG. 3f comprising other than the chat input field for allowing the first user to enter message information might be displayed on the display device. Additionally, a size of the video window 310-5 might be resized such that both the video window 310-5 and the group chat interface as shown in FIG. 3e might both be caused to appear on the display device, and the group chat interface as shown in FIG. 3e might comprise the chat input field to allow the first user to enter message information.

A second user associated with a second set top box might then select a messaging function to join the group chat session. The second set top box might first query the group chat server for a list of published group chat sessions that have been initiated for the video program. If there is not an existing group chat session, the second set top box might prompt the second user whether the second user wishes to host a group chat session. The effect of selecting the messaging function to join a group chat session might then be similar to selecting a messaging function to host a group chat session described above. If there are two or more group chat sessions, the second set top box might first cause a user interface to be displayed for the second user to select a group chat session. In some embodiments, the user interface might include additional information or special note that has been entered by the first user who initiated the group chat session. For example, if the second user lives in Springfield, the second user might prefer to join a group chat session directed to “Springfield viewers.”

Attention is directed back to FIG. 2b. In some embodiments, a request to join the group chat session by the second user might be sent to the group chat server, and the request is relayed to the first user for approval. At block 268, the first user might receive the request in a pop window or in a field that is displayed on a group chat interface for the first user. In other embodiments or if the first user has already closed the first user's group chat session, the second user might always be allowed to join the group chat session. At block 270, the group chat server might transmit chat messages that have been stored at the group chat server at block 264, noted above, in some embodiments. In such embodiments, the second user might be able to catch up and better follow discussions of the group chat session.

As alluded to earlier, in some embodiments, the group chat interface for the first user, who initiated the group chat session, might also include a field with a list of users who have joined the group chat session and a list of users who are requesting to be allowed to join the group chat session. In other embodiments, the second user might be presented with a group chat interface similar to that discussed above for the first user. For example, the group chat interface for the second user might also include a chat messages field, a chat session name, several chat action buttons, and a chat input field as discussed above. The second user might also be allowed to shrink and expand the group chat interface.

The second user might instead select a messaging function to initiate an instant messaging session. The second set top box that is associated with the second user might first present a user interface for the second user to specify whom the second user wishes to share an instant messaging session with. For example, the second user might enter a name and/or select a name from a list of names. Suppose the second user wishes to share an instant messaging session with the first user. Accordingly, at block 280, the second set top box that is associated with the second user might then send an initiating request to be received at an instant messaging server in order to initiate the instant messaging session. A portion of the initiating request might specify a second video program being viewed by the second user. After receiving the initiating request, the instant messaging server might transmit an invitation request to the set top box that is associated with the first user at block 282. Consequently, the set top box that is associated with the first user might receive the invitation request relating to initiating the instant messaging session from the instant messaging server at block 284.

At this time, the set top box might be causing a first video program to be displayed for the first user. The set top box might then prompt the first user to specify whether to join the instant messaging session initiated by the second user (block 286). For example, the set top box might cause a pop up window to be displayed for the first user to specify this choice. Additionally, the same pop up window or another pop up window might prompt the first user to specify whether to cause the display device to display the second video program that is specified in the invitation request. If the first user specifies to view the second video program (i.e., the second video program being viewed by the second user), the set top box might cause the display device to display the second video program at block 288. Additionally, if the first user specifies to join the instant messaging session, the first set top box might cause the display device to display an instant messaging interface at block 290.

The instant messaging interface that is displayed for both the first user and the second user might be very similar to the group chat interface discussed above. For example, the instant messaging interface might also include a messages field, several action buttons, and an input field. In some embodiments, no session name might be displayed; instead, it might be clear to the users that this is an instant messaging session, and/or the interface provided by the set-top box might provide an indication of the same. The users might also be allowed to shrink and expand the instant messaging interface. It is noted that in an embodiment, an instant messaging interface similar to the group chat interface as shown in FIG. 3d might not be implemented. This is because it might be desirable to be able to view the video program while exchanging messages. In another embodiment, an instant messaging interface similar to the group chat interface as shown in FIG. 3f might not be implemented. This is because it might not be desirable for one user to stay silent in an instant messaging session.

Accordingly, an instant messaging interface similar to the group chat interface as shown in FIG. 3e might be provided, in some embodiments. This instant messaging interface allows both users to view the video program while exchanging messages. In some embodiments, this instant messaging interface might be the default instant messaging interface that is displayed. To allow this instant messaging interface to be displayed, a size of the video window might be resized such that both the video program and the instant messaging interface appear simultaneously on the display device, and the instant messaging interface might comprise a messages field and a input field to allow the first user and the second user to view and enter messages. It will be understood by those skilled in the art that in certain embodiments that do not implement an instant messaging interface similar to the group chat interface as shown in FIG. 3d and/or FIG. 3f, the several action buttons might be adjusted accordingly. For example, only a send button and a close button might be implemented, and the buttons might be implemented as icons or other user interface elements.

After the first user specifies to join the instant messaging session, the first user might start by entering “Hello!” in the input field of the instant messaging interface for the first user. The first user might then press the send button or icon. The message that is created at block 230 might then comprise this instant message of the instant messaging session between the first user and the second user. Accordingly, a set of at least one IP packets is generated comprising the instant message at block 232, and the set of at least one IP packets is transmitted to the instant messaging server. At block 292, the set of at least one IP packets comprising the instant message might then be received at the instant messaging server. Subsequently, the instant messaging server might transmit the set of at least one IP packets comprising the instant message, via the IP network, to the second set top box at block 294. Consequently, at block 296, the instant message of the instant messaging session might be received at the second set top box, and the second set top box might cause the instant message to be displayed in the messages field of the instant messaging interface for the second user.

It will be understood that messages of the various embodiments might be captured by the interest aggregator 105 of the “DYNAMIC INTERACTIVE ADVERTISEMENT INSERTION INTO CONTENT STREAM DELIVERED THROUGH IP NETWORK” (“DIAD”) application that has been incorporated by reference. Additionally, in some embodiments, the interest aggregator 105 might consider other information about a video program, for example a program name and/or other metadata. It will also be understood that when the viewer profile 110 of other users is analyzed in various embodiments of the DIAD application, the viewer profile 110 among those who have exchanged messages might be analyzed first and/or given preference. The eventual display of an advertisement might be right away or on a delayed basis. For example, if a message is being sent about dinosaurs, the interest aggregator might capture one or more keywords from the message and store the one or more keywords in the viewer profile as an interested item. Subsequently, an advertisement relating to dinosaurs might be selected, and a content of the advertisement might then be inserted into an advertisement slot of the content stream.

Alternatively or in addition, an “advertisement slot” might comprise a portion of the screen play. Exemplary screen displays in accordance with various embodiments of the invention are shown in FIGS. 3g and 3h. (As noted above, the screen displays illustrated in the figures are exemplary in nature, and screen arrangements and techniques other than those illustrated in the figures could be used in accordance with various embodiments of the invention.) In FIG. 3g, the exemplary screen display is similar to that of FIG. 3d, except FIG. 3g includes an advertisement 380-7. In FIG. 3h, the exemplary screen display is similar to that of FIG. 3f, except FIG. 3h includes multiple advertisements 380-8. It will be understood that a size of the advertisement 380 might be smaller or large than those shown, and one of more advertisements 380 might be placed and/or overlaid at different portions of the screen display.

Additionally, another interest analyzer and/or advertisement selector might be used without using the viewer profile of the DIAD application in some embodiments. For example, the interest analyzer might have determined that the program name includes a keyword “dinosaur” and/or the messages include the same keyword. The keyword might be collected by the advertisement selector, and the advertisement selector might select an advertisement 380 based on the keyword. The advertisement selector might also select the advertisement 380 based on a size that is available to display the advertisement. The advertisement 380 might comprise banner advertisements and/or rich media including video. One or more advertisements 380 might also scroll across the screen display. As an additional example, in one embodiment, if the Survivor™ program is being displayed, advertisements might include DVD of previous Survivor™ episodes, Survivor™ memorabilia, and a travel destination near where the Survivor™ program is filmed. If a user enters “I really like the necklace she is wearing” in a message, the keywords “necklace” and “Survivor” might be used to select and display an advertisement relating to jewelry (e.g., an advertisement from a local or online seller of jewelry), necklaces especially, and if there might be a Survivor™ store that sells necklaces in particular.

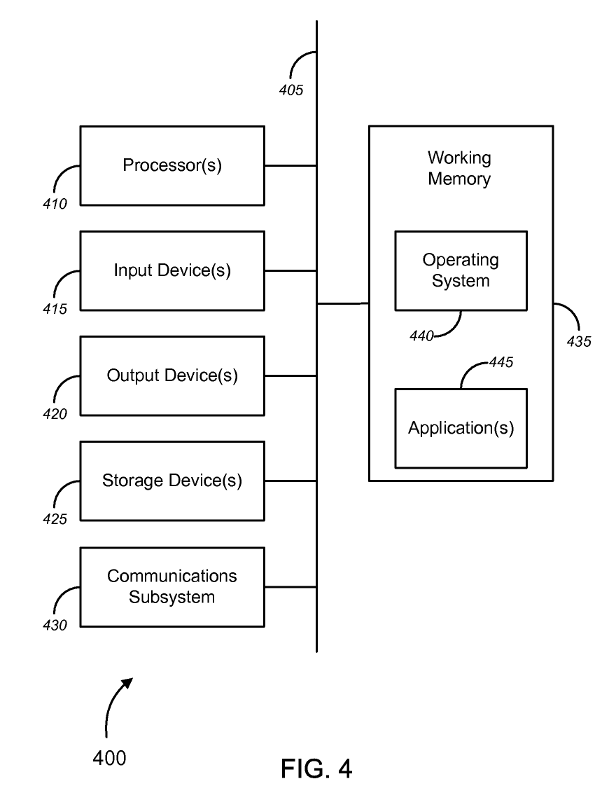

FIG. 4 provides a schematic illustration of one embodiment of a computer system 400 that can perform the methods provided by various other embodiments, as described herein, and/or can function as a server or an embodiment of a set top box. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, graphics acceleration processors, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), other computer systems, and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and or provided in an installation package, such that the storage medium can be used to program, configure and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer readable medium, such as one or more of the storage device(s) 425. Merely by way of example, execution of the sequences of instructions contained in the working memory 435 might cause the processor(s) 410 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 400, various computer readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 425. Volatile media includes, without limitation, dynamic memory, such as the working memory 435. Transmission media includes, without limitation, coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a storage device 425 either before or after execution by the processor(s) 410.

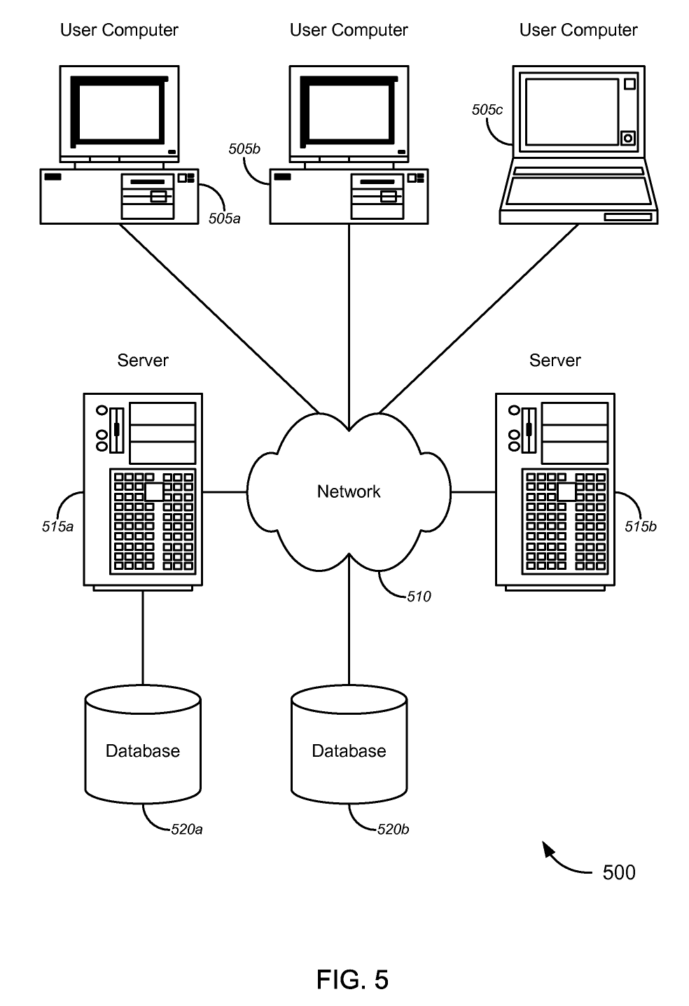

A set of embodiments comprises systems for supporting messaging. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ and/or Apple Inc.'s Macintosh™ operating systems) and/or workstation computers running any of a variety of commercially-available UNIX™ or UNIX-like operating systems. These user computers 505 can also have any of a variety of applications, including one or more applications configured to perform methods provided by various embodiments (as described above, for example), as well as one or more office applications, database client and/or server applications, and/or web browser applications. Alternatively, the user computers 505 can be any other electronic device, such as a thin-client computer, Internet-enabled mobile telephone, and/or personal digital assistant, capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially-available (and/or free or proprietary) protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 505 to perform methods of the invention.

The server computers 515, in some embodiments, might include one or more application servers, which can be configured with one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including without limitation those commercially available from Oracle, Microsoft, Sybase™, IBM™ and the like, which can process requests from clients (including, depending on the configuration, dedicated database clients, API clients, web browsers, etc.) running on a user computer 505 and/or another server 515. Data provided by an application server may be formatted as one or more web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement various disclosed methods, incorporated by an application running on a user computer 505 and/or another server 515. Alternatively, as those skilled in the art will appreciate, a file server can include all necessary files, allowing such an application to be invoked remotely by a user computer 505 and/or server 515.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as it can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 535 can be a relational database, such as an Oracle database, that is adapted to store, update, and retrieve data in response to SQL-formatted commands. The database might be controlled and/or maintained by a database server, as described above, for example.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of supporting messaging about a video program using a set top box, the method comprising:
receiving, at the set top box, video information related to the video program;
converting, at the set top box, the video information to allow for display of the video program on a display device;
displaying the video program on the display device;
receiving a request to display a menu of messaging functions, the request being entered by the first user;
displaying the menu of messaging functions, wherein the menu of messaging functions comprises:
a first messaging function to send program information of the video program to another user;
a second messaging function to join a group chat session;
a third messaging function to host a group chat session;
a fourth messaging function to initiate an instant messaging session; and
a fifth messaging function to call in to the video program;
receiving a selection from the menu of messaging functions, the selection being entered by the first user by pressing a portion of a remote control, wherein the selection is the third messaging function to host a group chat session;
receiving, at a group chat server and from the set top box, an initiating request to initiate the group chat session;
publishing, at the group chat server, a list of group chat sessions for each video program, the list of group chat sessions comprising the group chat session;
displaying a first version of a group chat interface, the first version of the group chat interface comprising other than an input field for allowing the first user to enter message information;
resizing a size of the video program such that both the video program and a second version of the group chat interface appear simultaneously on the display device, the second version of the group chat interface comprising the input field to allow the first user to enter message information;
creating, at the set top box and in accordance with input from a first user, a message to be sent from the first user to a second user, wherein the message is related to the video program;
generating, at the set top box, a set of at least one Internet Protocol (“IP”) packets comprising the message; and
transmitting the set of at least one IP packets from the set top box through an IP network to be received by an external device, the external device being separate from the set top box.

2. A method of supporting messaging about a video program using a set top box, the method comprising:
receiving, at the set top box, video information related to the video program;
converting, at the set top box, the video information to allow for display of the video program on a display device;
causing a display device to display the video program;
creating, at the set top box and in accordance with input from a first user, a message to be sent from the first user to a second user, wherein the message is related to the video program;
generating, at the set top box, a set of at least one Internet Protocol (“IP”) packets comprising the message; and
transmitting the set of at least one IP packets from the set top box through an IP network to be received by an external device, the external device being separate from the set top box.

3. The method of claim 2, further comprising:
receiving a request to display a menu of messaging functions, the request being entered by the first user;
causing the display device to display the menu of messaging functions; and
receiving a selection from the menu of messaging functions, the selection being entered by the first user.

4. The method of claim 3, wherein the request is entered by pressing a portion of a remote control.

5. The method of claim 2, further comprising:
causing the display device to display a messaging interface for the first user; and
wherein the input from the first user is received via the messaging interface.

6. The method of claim 5, wherein the messaging interface provides for the first user a message template comprising program information pertaining to the video program, the program information being generated by the set top box without requiring entry by the first user and comprising a program name, a program date, and a program time, the method further comprising:
receiving, from the first user and via the messaging interface, an identification of a destination for the message; and
wherein transmitting the set of at least one IP packets comprises transmitting a content of the message template to the destination for the message.

7. The method of claim 6, wherein the messaging interface further comprises an input field to allow the first user to enter additional message information, and wherein transmitting the set of at least one IP packets further comprises transmitting the additional message information.

8. The method of claim 5, wherein causing the display device to display a messaging interface for the first user comprises:
resizing a size of the video program such that both the video program and the messaging interface appear simultaneously on the display device, wherein the messaging interface comprises an input field to allow the first user to enter additional message information.

9. The method of claim 2, wherein the external device is configured to record, based at least in part on the message created at the set top box, the video program from video information received from a source other than the set top box.

10. The method of claim 9, wherein the set top box is a first set top box and the external device is a second set top box, the method further comprising:
receiving the message at the second set top box; and
recording, based at least in part on an instruction in the message, the video program at a digital video recorder in communication with the second set top box.

11. The method of claim 9, further comprising:
prompting, at the external device, the second user to specify whether to record the video program; and
wherein the external device is configured to record the video program based further on receiving a specification from the second user to record the video program.

12. The method of claim 9, further comprising:
allowing the second user to specify, prior to receiving the message at the external device, a set of rules governing whether the external device will record the video program; and
wherein the external device is configured to record the video program based further on the set of rules.

13. The method of claim 9, further comprising:
searching a programming guide to find an end time of the video program.

14. The method of claim 2, wherein the external device is associated with a provider of the video program and the message comprises a request to initiate a voice call session between the first user and at least one participant in the video program, the method further comprising:
receiving, at the set top box and from the external device, a second message accepting the request to initiate the voice call; and
establishing, in response to the second message, a voice call session between the set top box and the external device.

15. The method of claim 14, wherein the voice call session supports at least a voice over IP communication between the first user and the at least one participant in the video program.

16. The method of claim 2, wherein the message comprises a chat message of a group chat session and the external device is a group chat server, the method further comprising:
receiving, at the group chat server and from the set top box, an initiating request to initiate the group chat session;
receiving, at the group chat server and from the set top box, the chat message of the group chat session; and
storing, at the group chat server, the chat message of the group chat session.

17. The method of claim 16, the method further comprising:
publishing, at the group chat server, a list of group chat sessions for each video program, the list of group chat sessions comprising the group chat session;
allowing the second user to join the group chat session by selecting, at a third device associated with the second user, the group chat session from the list of group chat sessions; and
transmitting, from the group chat server, the stored first message of the group chat session to the third device.

18. The method of claim 16, the method further comprising:
causing the display device to display a first version of a group chat interface, the first version of the group chat interface comprising other than an input field for allowing the first user to enter message information; and
resizing a size of the video program such that both the video program and a second version of the group chat interface appear simultaneously on the display device, the second version of the group chat interface comprising the input field to allow the first user to enter message information.

19. The method of claim 2, wherein the message comprises an instant message of an instant messaging session between the first user and the second user, the method further comprising:
receiving, at the set top box and from the external device, an invitation request relating to initiating the instant messaging session, wherein the instant messaging session is initiated by the second user;
prompting, at the set top box, the first user to specify whether to join the instant messaging session;
causing the display device to display an instant messaging interface if the first user specifies to join the instant messaging session; and
receiving, by the second user and from the first user, the instant message of the instant messaging session, wherein the input from the first user is received at the set top box via the instant messaging interface.

20. The method of claim 19, wherein the video program is a first video program, further comprising:
prompting, at the set top box, the first user to specify whether to cause the display device to display a second video program, wherein the second video program is specified in the invitation request.

21. The method of claim 19, wherein the external device is an instant messaging server, the method further comprising:
receiving, at the instant messaging server, an initiating request to initiate the instant messaging session from a third device associated with the second user;
transmitting the invitation request from the instant messaging server to the set top box, wherein the invitation request is transmitted as a result of receiving the initiating request;
receiving the instant message at the instant messaging server; and
transmitting the instant message from the instant messaging server, via the IP network, to the third device.

22. The method of claim 19, wherein causing the display device to display an instant messaging interface comprises:
resizing a size of the video program such that both the video program and the instant messaging interface appear simultaneously on the display device, wherein the instant messaging interface comprises an input field to allow the first user to enter messages.

23. The method of claim 2, further comprising:
selecting an advertisement based on a content of the message; and
causing the display device to display the advertisement.

24. A device for supporting messaging about a video program, the device comprising:
a processor; and
a computer readable medium in communication with the processor, the computer readable medium having encoded thereon a set of instructions by the device to perform one or more operations, the set of instructions comprising:
instructions for receiving video information related to the video program;
instructions for converting the video information to allow for display of the video program on a display device;
instructions for causing the display device to display the video program;
instructions for creating, in accordance with input from a first user, a message to be sent from the first user to a second user, wherein the message is related to the video program;
instructions for generating a set of at least one Internet Protocol (“IP”) packets comprising the message; and
instructions for transmitting the set of at least one IP packets from the set top box through an IP network to be received by an external device, the external device being separate from the set top box.

25. A system for supporting messaging about a video program, the system comprising:
a server;
an input device;
a display device; and
a set top box configured to:
receive video information related to the video program;
convert the video information to allow for display of the video program on a display device;
cause the display device to display the video program;
create, in accordance with input from a first user, a message to be sent from the first user to a second user, wherein the message is related to the video program;
generate a set of at least one Internet Protocol (“IP”) packets comprising the message; and
transmit the set of at least one IP packets from the set top box through an IP network to be received by an external device, the external device being separate from the set top box.

26. A computer readable medium having encoded thereon a computer program comprising a set of instructions that are executable by a computer system to perform one or more operations to support messaging about a video program using a set top box, the set of instructions comprising:
instructions for receiving video information related to the video program;
instructions for converting the video information to allow for display of the video program on a display device;
instructions for causing the display device to display the video program;
instructions for creating, in accordance with input from a first user, a message to be sent from the first user to a second user, wherein the message is related to the video program;
instructions for generating a set of at least one Internet Protocol (“IP”) packets comprising the message; and
instructions for transmitting the set of at least one IP packets from the set top box through an IP network to be received by an external device, the external device being separate from the set top box.
